(19) United States
(12) Patent Application Publication
(10) Pub. No.: US 2025/0300308 A1
(43) Pub. Date: Sep. 25, 2025

(54) BATTERY MODULE AND BATTERY PACK

(71) Applicant: Zhejiang Jinko Energy Storage Co., Ltd., Haining City (CN)

(72) Inventors: Yuanfu LV, Haining City (CN); Yuanhang CHEN, Haining City (CN); Guochao CHEN, Haining City (CN)

(21) Appl. No.: 18/936,941

(22) Filed: Nov. 4, 2024

(30) Foreign Application Priority Data
Mar. 22, 2024 (CN) 202410338036.4
Mar. 22, 2024 (CN) 202410338406.4

(51) Int. Cl. H01M 50/296; H01M 50/204

(52) U.S. Cl. CPC H01M 50/296; H01M 50/204

(57) ABSTRACT

A battery module includes: an end plate, including an output electrode pedestal mounting slot; and an output electrode pedestal, including a base and an output electrode connector, wherein a side wall of the base is engaged with a side wall of the output electrode pedestal mounting slot, and the base includes a first receiving cavity; wherein the output electrode connector includes a connecting pedestal and a connecting portion, the connecting pedestal includes a second receiving cavity, a side wall of the connecting pedestal is engaged with a side wall of the first receiving cavity, and the connecting portion is located in the second receiving cavity and movable in translation within the second receiving cavity. The present disclosure is at least beneficial to improve the reliability of the electrical connection of the output electrode of the battery module.

### CROSS REFERENCE TO RELATED APPLICATIONS

The present application claims the benefit of priority under Paris Convention to Chinese Patent Application No. 202410338036.4, entitled “BATTERY MODULE AND BATTERY PACK”, filed on Mar. 22, 2024, and to Chinese Patent Application No. 202410338406.4, entitled “BATTERY MODULE AND BATTERY PACK”, filed on Mar. 22, 2024, both of which are incorporated herein by reference in its entirety.

### TECHNICAL FIELD

Embodiments of the present disclosure relates to the technical field of energy storage, and in particular to, a battery module and a battery pack.

### BACKGROUND

With the development and changes of technology, household energy storage systems and high-capacity energy storage systems have gradually matured, greatly improving the reliability of power supply for users. An energy storage system is generally formed by combining multiple battery cells into one battery module, then installing multiple battery modules in series and parallel inside one battery pack, then installing electrical components and securing them with structural fasteners, and finally installing multiple battery packs on a battery rack to form one battery cluster, and then combining one or more battery clusters with a corresponding monitoring and management system to form one energy storage system.

The battery module assembled inside the battery pack generally includes an end plate, an integrated busbar, multiple cells, and cell fixing steel strips. Multiple cells are electrically connected in series and/or parallel, and an output electrode pedestal arranged on the end plate is used as an electrical energy output port of the battery module. The output electrode pedestal is electrically connected to one electrode of an edge cell of the battery module through a copper busbar or aluminum bar.

### SUMMARY

Embodiments of the present disclosure provide a battery module and a battery pack that are at least conducive to absorbing tolerances of copper busbars or aluminum bars during manufacturing process, and improving the reliability of the electrical connection between output electrode and emitter electrode of the battery module.

The battery module provided by the embodiments of the present disclosure includes: an end plate including an output electrode pedestal mounting slot; and an output electrode pedestal including a base and an output electrode connector. A side wall of the base is engaged with a side wall of the output electrode pedestal mounting slot, and the base includes a first receiving cavity extending from a top surface of the base to an interior of the base. The output electrode connector includes a connecting pedestal and a connecting portion, the connecting pedestal includes a second receiving cavity, a top surface of the connecting pedestal has an opening that runs through a top of the connecting pedestal to expose the connecting portion inside the second receiving cavity, a side wall of the connecting pedestal is engaged with a side wall of the first receiving cavity, and the connecting portion is located in the second receiving cavity and movable in translation within the second receiving cavity.

In some embodiments, the maximum translation distance of the connecting portion within the second receiving cavity is less than or equal to 8 mm.

In some embodiments, an inner wall of the first receiving cavity includes at least two opposite position-limiting slots, and an outer wall of the connecting pedestal has at least two opposite position-limiting portions, each of the position-limiting portions being engaged into a corresponding position-limiting slot.

In some embodiments, in a direction perpendicular to the top surface of the second receiving cavity, a first cross-section of the second receiving cavity is polygonal, and a second cross-section of the connecting portion is polygonal.

In some embodiments, the number of sides of the first cross-section and/or the second cross-section is 3 to 6.

In some embodiments, the first cross-section and the second cross-section have the same shape.

In some embodiments, the base further includes an installation groove located on the side wall of the base and extending along a second direction, an angle between the second direction and a top surface of the end plate being less than or equal to 10°; and the end plate further includes a position-limiting crossbeam, a side wall of the position-limiting crossbeam being engaged with a side wall of the installation groove.

In some embodiments, the second direction is parallel to the top surface of the end plate.

In some embodiments, the side wall of the base further includes at least one placement hole running through the thickness of the side wall of the base; in a direction perpendicular to the top surface of the second receiving cavity, a thickness of the connecting portion is smaller than a height of the second receiving cavity, and a third receiving cavity is formed between a top surface of the connecting portion and the top surface of the second receiving cavity, the placement hole directly facing the third receiving cavity and a bottom surface of the placement hole being higher than the top surface of the connecting portion.

In some embodiments, in a direction perpendicular to the top surface of the second receiving cavity, the height of the placement hole is between 1 mm and 3 mm.

Another battery module provided by the embodiments of the present disclosure includes: an output electrode pedestal, including a base and an output electrode connector. The top surface of the base has a first slot extending towards the interior of the base along a first direction perpendicular to the top surface of the base. A side wall of the output electrode connector is engaged with a side wall of the first slot, and in the first direction, the depth of the first slot is greater than or equal to the length of the output electrode connector, and the output electrode connector is able to reciprocate in the first direction within the first slot; and an end plate including a pedestal position-limiting slot, a side wall of the pedestal position-limiting slot being engaged with a side wall of the base.

In some embodiments, a cross-section of the output electrode connector is polygonal.

In some embodiments, the depth of the first slot along the first direction is less than or equal to 2 cm.

In some embodiments, the top surface of the base further has a second slot extending towards the interior of the base along the first direction and towards an edge of the base along the second direction, the second slot being communicated with the first slot; and the output electrode connector is able to move along the second direction from the first slot to the second slot and be engaged with part of a side wall of the second slot.

In some embodiments, the distance between the second slot and the edge of the base in the second direction is between 3 mm and 10 mm.

In some embodiments, the extension length of the second slot is between 1 mm and 4 mm.

In some embodiments, the top surface of the base further has a third slot extending towards the interior of the base along the first direction and towards the edge of the base along a third direction perpendicular to the second direction, the third slot being communicated with the first slot; the output electrode connector is able to move along the third direction from the first slot to the third slot and be engaged with part of a side wall of the third slot.

In some embodiments, the distance between the third slot and the edge of the base in the third direction is between 10 mm and 25 mm.

In some embodiments, the extension length of the third slot in the third direction is between 1 mm and 4 mm.

In some embodiments, the base further includes an installation rail located on the side wall of the base and extending along a fourth direction, an angle between the fourth direction and the top surface of the base being less than or equal to 10°; and the end plate further includes a fixing portion, a side wall of the fixing portion being engaged with a side wall of the installation rail.

In some embodiments, the fourth direction is parallel to the top surface of the base.

Correspondingly, the embodiments of the present disclosure further provide a photovoltaic module including: multiple battery modules as described above.

The technical solution provided in the embodiments of the present disclosure has at least the following advantages:

In the battery module provided by the embodiments of the present disclosure, an output electrode pedestal mounting slot is provided on the end plate of the battery module, and the output electrode pedestal is composed of a base and an output electrode connector. The side wall of the base can be engaged with the side wall of the output electrode pedestal mounting slot, so that the output electrode pedestal can be securely installed on the end plate and can accurately anchor the connection position of the output electrode pedestal with the aluminum bar or copper busbar; the top surface of the base of the output electrode pedestal has a first receiving cavity extending from the top surface of the base towards the interior of the base and configured to receive the output electrode connector. The output electrode connector is composed of a connecting pedestal engaged with the side wall of the first receiving cavity and a connecting portion located in a second receiving cavity of the connecting pedestal. The side wall of the connecting pedestal is engaged with the side wall of the first receiving cavity so that the output electrode connector can be securely fixed in the base; the top surface of the connecting pedestal has an opening that runs through the top of the second receiving cavity, and the connecting portion can move in translation in the receiving cavity, or the top surface of the base of the output electrode pedestal has a first slot extending along a first direction from the top surface of the base towards the interior of the base and configured to receive the output electrode connector, wherein the side wall of the output electrode connector is engaged with the side wall of the first slot, and the output electrode connector can freely reciprocate along the first direction in the first slot, so that the actual connection position of the connecting portion with the aluminum bar or copper busbar can be finely adjusted, thereby absorbing the manufacturing tolerance of the aluminum bar or copper busbar in the manufacturing process, improving the reliability of the electrical connection between the connecting portion and the aluminum bar or copper busbar, and facilitating the assembly of the battery module.

### BRIEF DESCRIPTION OF THE DRAWINGS

One or more embodiments are illustrated through the figures in the corresponding drawings. These exemplary illustrations do not constitute limitations on the embodiments unless otherwise stated. The figures in the accompanying drawings do not constitute a scale limitation.

FIG. 1 is a schematic structural view of an end plate provided in an embodiment of the present disclosure;

FIG. 2 is a schematic structural view of an output electrode connector provided in an embodiment of the present disclosure;

FIG. 3 is a bottom view of a connecting portion provided in an embodiment of the present disclosure;

FIG. 4 is a partial side view of a base provided in an embodiment of the present disclosure;

FIG. 5 is a partial cross-sectional view of a base provided in an embodiment of the present disclosure;

FIG. 6 is a side view of a connecting pedestal provided in an embodiment of the present disclosure;

FIG. 7 is a partial cross-sectional view of an output electrode connector provided in an embodiment of the present disclosure;

FIG. 8 is a schematic structural view of another end plate provided in an embodiment of the present disclosure;

FIG. 9 is a schematic structural view of another output electrode connector provided in an embodiment of the present disclosure;

FIG. 10 is a schematic cross-sectional view of another output electrode connector provided in an embodiment of the present disclosure;

FIG. 11 is a top view of another base provided in an embodiment of the present disclosure;

FIG. 12 is a top view of another base provided in an embodiment of the present disclosure;

FIG. 13 is a partial side view of another base provided in an embodiment of the present disclosure; and

FIG. 14 is a partial cross-sectional view of another base provided in an embodiment of the present disclosure.

### DETAILED DESCRIPTION OF THE EMBODIMENTS

As is known from the background technology, the output electrode pedestal of the existing battery module is electrically connected to one electrode of an edge cell of the battery module through a copper busbar or aluminum bar. Due to the manufacturing process, the aluminum bar or copper busbar may have certain manufacturing tolerances, and in the process of electrically connecting the aluminum bar or copper busbar to the output electrode pedestal that is completely fixed in a designated position, it is easy to encounter assembly difficulties or unstable electrical connections, which in turn affects the reliability of the battery module.

Embodiments of the present disclosure provide a battery module. An output electrode pedestal mounting slot is provided on an end plate of the battery module, and an output electrode pedestal is composed of a base and an output electrode connector. The side wall of the base can be engaged with the side wall of the output electrode pedestal mounting slot, so that the output electrode pedestal can be securely installed on the end plate and can accurately anchor the connection position of the output electrode pedestal with the aluminum bar or copper busbar; the top surface of the base of the output electrode pedestal has a first receiving cavity extending from the top surface of the base towards the interior of the base and configured to receive the output electrode connector, wherein the output electrode connector is composed of a connecting pedestal engaged with the side wall of the first receiving cavity and a connecting portion located in a second receiving cavity of the connecting pedestal, wherein the side wall of the connecting pedestal is engaged with the side wall of the first receiving cavity so that the output electrode connector can be securely fixed in the base; the top surface of the connecting pedestal has an opening that runs through the top of the second receiving cavity, and the connecting portion can move in translation in the receiving cavity, so that the actual connection position of the connecting portion with the aluminum bar or copper busbar can be finely adjusted, thereby absorbing the manufacturing tolerance of the aluminum bar or copper busbar in the manufacturing process, improving the reliability of the electrical connection between the connecting portion and the aluminum bar or copper busbar, and facilitating the assembly of the battery module.

As used in this paper, features (for example, regions, structures, devices) described as “adjacent” imply and encompass features that are located closest to each other (for example, the nearest) and possess one or more disclosed identifiers. One or more additional features with disclosed identifiers (for example, additional regions, structures, or devices) that do not match the “adjacent” features may be disposed between the “adjacent” features. In other words, the “adjacent” features may be located directly next to each other with no other features intervening between the “adjacent” features; or the “adjacent” features may be located indirectly next to each other, such that at least one feature with an identifier other than that associated with at least one “adjacent” feature is positioned between the “adjacent” features. Therefore, the features described as “vertically adjacent” to each other imply and encompass the features disclosed by one or more identifiers and located vertically closest to each other (for example, vertically nearest). Furthermore, the features described as “horizontally adjacent” to each other imply and encompass the features disclosed by one or more identifiers and located horizontally closest to each other (for example, horizontally nearest).

In the following description, the expression that a second component is formed or disposed above or on a first component, or a second component is formed or disposed on a surface of a first component, or a second component is formed or disposed on one side of the first component, may encompass embodiments in which the first and second components are in direct contact, and may also encompass embodiments in which additional components may be disposed between the first and second components and the first and second components are therefore in indirect contact. For simplicity and clarity, various components may be drawn at any scale. In the accompanying drawings, some layers/components may be omitted for simplicity.

The following provides a detailed description of the embodiments of the present disclosure in conjunction with the accompanying drawings. However, those of ordinary skill in the art may understand that in various embodiments of the present disclosure, many technical details have been presented to facilitate a better understanding of the present disclosure by the reader. However, even without these technical details and the various variations and modifications based on the following embodiments, the technical solution claimed in the present disclosure can still be achieved.

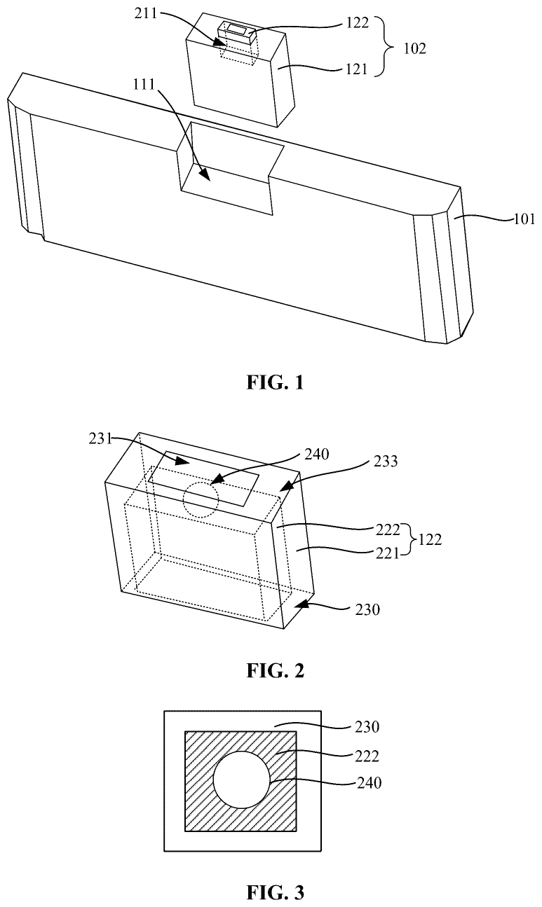

An embodiment of the present disclosure provides a battery module. Referring to FIG. 1 and FIG. 2, FIG. 1 is a schematic structural view of an end plate, and FIG. 2 is a schematic structural view of an output electrode connector. The battery module includes: an end plate 101 including an output electrode pedestal mounting slot 111; and an output electrode pedestal 102, including a base 121 and an output electrode connector 122, wherein a side wall of the base 121 is engaged with a side wall of the output electrode pedestal mounting slot 111, and the base 121 includes a first receiving cavity 211 extending from a top surface of the base 121 to the interior of the base 121; wherein the output electrode connector 122 includes a connecting pedestal 221 and a connecting portion 222, the connecting pedestal 221 including a second receiving cavity 230, a top surface of the connecting pedestal 221 having an opening 231 that runs through the top 233 of the connecting pedestal 221, a side wall of the connecting pedestal 221 being engaged with a side wall of the first receiving cavity 211, and the connecting portion 222 being located in the second receiving cavity 230 and movable in translation within the second receiving cavity 230.

For ease of understanding, FIG. 1 illustrates the example where the output electrode pedestal 102 is not fixed and engaged with the end plate 101. The end plate 101 in the battery module is adjacent to an edge cell in the battery module. The output electrode pedestal mounting slot 111 is provided on the end plate 101 for fixing the output electrode pedestal 102. The output electrode pedestal 102 includes the connecting portion 222 connected to one electrode of the edge cell in the battery module. The connecting portion 222 is electrically connected to one electrode of the edge cell through an aluminum bar or copper busbar, so that the connecting portion 222 on the end plate 101 on one side of the battery module can serve as one output electrode in the battery module. Similarly, the connecting portion 222 on the end plate 101 on the other side can serve as another output electrode, thereby outputting the electrical energy stored by multiple cells in the battery module.

In the process of configuring the output electrode pedestal 102, the output electrode pedestal mounting slot 111 may be formed on the end plate 101 first, and the output electrode pedestal 102 may be configured as a composite device composed of the base 121 and the output electrode connector 122, wherein the base 121 and the output electrode pedestal mounting slot 111 have similar shapes, so that the side wall and bottom surface of the base 121 can be engaged with the output electrode pedestal mounting slot 111, thereby securely fixing the output electrode pedestal 102 onto the end plate 101.

The depth of the output electrode pedestal mounting slot 111 on the end plate 101 may be greater than or equal to the height of the output electrode pedestal 102. In the case that the depth of the output electrode pedestal mounting slot 111 is greater than the height of the output electrode pedestal 102, the output electrode pedestal 102 is installed in a semi suspended manner, so that after the output electrode pedestal 102 is mounted on the end plate 101, only the side wall of the base 121 is engaged with the side wall of the output electrode pedestal mounting slot 111, and the bottom surface of the base 121 is not in contact with the end plate 101. In addition, the bottom surface of the base 121 may also be in contact with the output electrode pedestal mounting slot 111, further improving the engagement effect of the output electrode pedestal 102 on the end plate 101. The depth of the output electrode pedestal mounting slot 111 refers to the maximum extension length of the output electrode pedestal mounting slot 111 into the end plate 101 along a direction perpendicular to the end plate 101, and the height of the output electrode pedestal 102 refers to the maximum distance between two opposing points on the output electrode pedestal 102 along a direction perpendicular to the end plate 101.

The end plate 101 may also have fixing portions oppositely arranged. The fixing portions may be located at the top of the output electrode pedestal mounting slot 111, and the projections of the fixing portions in a direction extending from the output electrode pedestal mounting slot 111 towards the end plate 101 are at least partially located inside the output electrode pedestal mounting slot 111, so that the fixing portions can contact the top surface of the output electrode pedestal 102. Thus, a closed space with a top opening can be formed by using the fixing portions and the output electrode pedestal mounting slot 111, greatly improving the fixing effect of the output electrode pedestal 102 on the end plate 101 and reducing the probability of the output electrode pedestal 102 sliding out of the output electrode pedestal mounting slot 111.

The connecting pedestal 221 includes a second receiving cavity 230. A top surface of the connecting pedestal 221 has an opening 231 that runs through the top 233 of the connecting pedestal 221 to expose the connecting portion 222 inside the second receiving cavity 230. A side wall of the connecting pedestal 221 is engaged with a side wall of the first receiving cavity 211. The connecting portion 222 is located in the second receiving cavity 230 and is movable in translation within the second receiving cavity 230. In the case that the connecting pedestal 221 is engaged with the first receiving cavity 211, the output electrode connector 122 can be securely engaged in the base 121. The output electrode connector 122 has the second receiving cavity 230, and the top surface of the connecting pedestal 221 has an opening 231 that runs through the top 233 of the connecting pedestal 221, so that the connecting portion 222 placed in the second receiving cavity 230 can be effectively exposed, thereby facilitating the electrical connection of the connecting portion 222 with the aluminum bar or copper busbar. As the connecting portion 222 can move in translation in the second receiving cavity 230, the actual position of the electrical connection of the connecting portion 222 with the aluminum bar or copper busbar can have a certain degree of flexibility, which can effectively absorb the manufacturing tolerances of electrical connectors such as the aluminum bar and copper busbar during the manufacturing process, thereby improving the reliability of the electrical connection between the output electrode base 102 and cell electrodes.

It is worth mentioning that the battery module may also include multiple cells sequentially arranged in a predetermined direction, an integrated busbar arranged on the top surface of the cells and configured on the basis of the connection method of the cells in the battery module, steel strips in contact with the end plate and the side walls of the cells for fixing and bundling the multiple cells, and other components. For ease of understanding and description, the relevant components are not shown in the figures. In addition, the end plate 101 and the output electrode pedestal 102 may be formed through an integrated forming process, or they can be separately formed and then assembled, which is not limited by the embodiments of the present disclosure.

Referring to FIG. 2 and FIG. 3, in some embodiments, in a direction perpendicular to the top surface of the second receiving cavity 230, a first cross-section of the second receiving cavity 230 is polygonal, and a second cross-section of the connecting portion 222 is polygonal. FIG. 3 is an orthographic projection view of the connecting portion 222 on the bottom surface of the second receiving cavity 230.

In the process of configuring the output electrode pedestal 102, the connecting portion 222 is generally in the form of a nut like component with threads or other fixing slots, and the fixed connection between the connecting portion 222 and the aluminum bar or copper busbar is generally achieved through screw fastening. In order to prevent the connecting portion 222 from easily rotating in the second receiving cavity 230, the first cross-section of the second receiving cavity 230 along the direction perpendicular to the top surface of the second receiving cavity 230 and the second cross-section of the connecting portion 222 along the direction perpendicular to the top surface of the second receiving cavity 230 may be configured into a polygonal shape, so that during the process of fixing the connecting portion 222 and the aluminum bar or copper busbar, at least part of the side wall of the connecting portion 222 can effectively engage with the side wall of the second receiving cavity 230, thereby restricting the rotation of the connecting portion 222 and facilitating fixation of the connecting portion 222 and the copper busbar or aluminum bar.

FIG. 3 illustrates the example where both the first and second cross-sections are regular quadrilaterals. In some embodiments, the first and second cross-sections may have different shapes. For example, the first cross-section is a regular quadrilateral and the second cross-section is a regular triangle; the first cross-section is a regular hexagon and the second cross-section is a regular quadrilateral; or the first cross-section is a regular quadrilateral and the second cross-section is a regular hexagon. In addition, the first cross-section and the second cross-section may also have the same shape. For example, both the first cross-section and the second cross-section are regular quadrilaterals, regular pentagons, regular hexagons, etc. The first cross-section and the second cross-section may be patterns with the same shape or different shapes, so that the output electrode connector 122 can be compatible with different scene requirements,

In addition, the first and second cross-sections may not only be regular polygons, but also other polygon patterns, such as parallelograms, rectangles, trapezoids, or other irregular polygons, which are not limited by the embodiments of the present disclosure.

In some embodiments, the first cross-section and the second cross-section are regular polygons with the same shape, and the ratio of the area of the first cross-section to the area of the second cross-section is between 1.05 and 1.5. In the case that both the first cross-section and the second cross-section are regular polygons, the ratio of their areas affects the degrees of freedom of the connecting portion 222 in the second receiving cavity 230. Therefore, the ratio of the area of the first cross-section to the area of the second cross-section may be set between 1.05 and 1.5, such as 1.1, 1.15, 1.25, 1.35, or 1.5. On the one hand, such ratio allows the connecting portion 222 to have sufficient degrees of freedom in the second receiving cavity 230, that is, to perform a sufficiently large translation. On the other hand, such ratio enables the side wall of the connecting portion 222 to effectively engage with the side wall of the second receiving cavity 230, avoiding the connecting portion 222 from easily rotating due to excessive freedom and from further affecting the fixing effect of the connecting portion 222 with the copper busbar or aluminum bar, and improving the reliability of the output electrode pedestal 102.

In some embodiments, the number of sides of the first cross-section and/or the second cross-section is 3 to 6.

In order to ensure that it is easy to manufacture the second receiving cavity 230 and the connecting portion 222, and that the second receiving cavity 230 has sufficient space, the first and second cross-sections generally are approximately regular polygons. Taking both the first and second cross-sections being regular polygons as an example, the more sides the first cross-section contains, the more circular the first cross-section becomes, that is, the lower the roughness of the inner wall of the second receiving cavity 230. Similarly, the more sides the second cross-section contains, the lower the roughness of the side wall of the connecting portion 222. In the case that at least one of the first and second cross-sections contains an excessive number of sides, the engagement effect between the connecting portion 222 and the inner wall of the second receiving cavity 230 significantly decreases, and the connecting portion 222 is prone to rotation during the process of electrically connecting the connecting portion 222 with the aluminum bar or copper busbar, which in turn affects the fixing effect and efficiency.

Therefore, the number of sides contained by the first cross-section may be set within the range of 3 to 6, such as 3, 4, or 5. Similarly, the number of sides contained by the second cross-section may also be set within the range of 3 to 6, such as 4, 5, or 6, so that the inner wall of the second receiving cavity 230 and/or the side wall of the connecting portion 222 have sufficient roughness, thereby reducing the probability of rotation of the connecting portion 222 during the fixing process with the aluminum bar or copper busbar, and improving the fixing effect and efficiency.

In some embodiments, the maximum translation distance of the connecting portion 222 within the second receiving cavity 230 is less than or equal to 8 mm.

The translation distance of the connecting portion 222 within the second receiving cavity 230 refers to the translation distance of the center of the connecting portion 222 during its movement from a first position to a second position in the second receiving cavity 230. The purpose of the configuration that the connecting portion 222 is able to translate a certain distance within the second receiving cavity 230 is to utilize the translation of the connecting portion 222 to absorb the manufacturing tolerances of components such as the aluminum bar or copper busbar, thereby improving the fixing effect of the connecting portion 222 with the aluminum bar or copper busbar. Taking the center of the connecting portion 222 being at the center of a bottom surface of the second receiving cavity 230 as an example, in the case that the maximum translation distance of the connecting portion 222 towards an edge of the second receiving cavity 230 is too large, the size of the second receiving cavity 230 and the output electrode connector 122 is large, requiring a large space, and the degree of freedom of the connecting portion 222 is too high, the connecting portion 222 being prone to rotation. Therefore, the maximum translation distance of the connecting portion 222 from the center of the bottom surface of the second receiving cavity 230 towards the edge may be set to a value less than or equal to 4 mm. In other words, the maximum translation distance of the connecting portion 222 within the second receiving cavity 230 may be set to a value less than or equal to 8 mm, such as 7.5 mm, 7 mm, 6 mm, 5 mm, 3.5 mm, or 2 mm. Such configuration can effectively absorb the manufacturing tolerances of the aluminum bar or copper busbar fixedly connected with the connecting portion 222, thereby improving the fixing effect of the connecting portion 222 with the aluminum bar or copper busbar.

In addition, taking the center of the connecting portion 222 being at the center of the bottom surface of the second receiving cavity 230 as an example, in the case that the maximum translation distance of the connecting portion 222 towards the edge of the second receiving cavity 230 is too small, the degree of freedom of the connecting portion 222 in the second receiving cavity 230 is low, and it may not be able to fully or effectively absorb the manufacturing tolerances of the copper busbar or aluminum bar. Therefore, by adjusting the parameters of the connecting portion 222 and the second receiving cavity 230, the maximum translation distance of the connecting portion 222 in the second receiving cavity 230 can be within the range of 2 mm to 8 mm, such as 7.5 mm, 6.5 mm, 5 mm, 3.5 mm, or 2.5 mm. Such configuration can effectively absorb the manufacturing tolerances of the aluminum bar or copper busbar fixedly connected with the connecting portion 222, thereby improving the fixing effect of the connecting portion 222 with the aluminum bar or copper busbar.

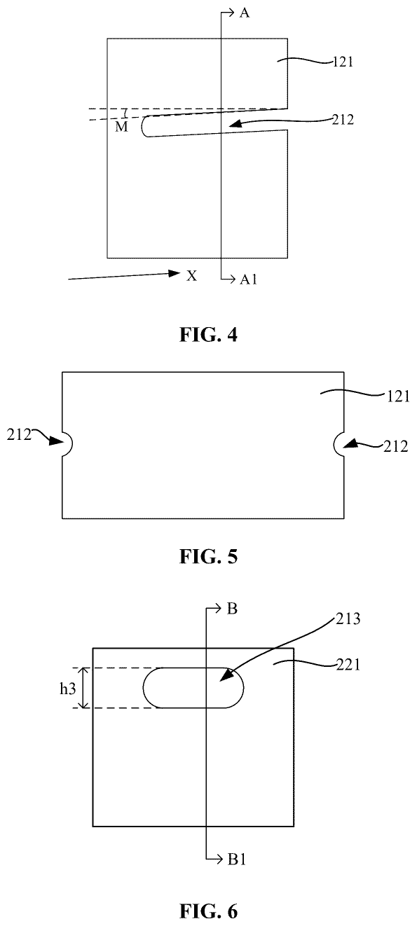

Referring to FIG. 4 and FIG. 5, in some embodiments, the base 121 further includes an installation groove 212 located on the side wall of the base 121 and extending along a first direction, an angle between the first direction and the top surface of the end plate 101 being less than or equal to 10°; and the end plate 101 further includes a position-limiting crossbeam (not shown), a side wall of the position-limiting crossbeam being engaged with a side wall of the installation groove 212. FIG. 4 is a partial side view of the base 121, and FIG. 5 is a partial cross-sectional view of the base 121 taken along AA1 direction, wherein X direction represents the first direction.

In the process of arranging the output electrode pedestal 102, the output electrode pedestal 102 is generally vertically inserted into the output electrode pedestal mounting slot 111. However, after the assembly of the entire battery module is finished, the integrated busbar covers at least part of the area directly above the output electrode pedestal 102. In the case of a malfunction of the output electrode pedestal 102, the disassembly and maintenance of the output electrode pedestal 102 are difficult due to the obstruction from the integrated busbar.

Therefore, in the process of arranging the output electrode pedestal 102, the output electrode pedestal 102 may be arranged in the horizontal direction or in a direction that has a certain angle with the horizontal direction. Since the placement direction of the output electrode pedestal 102 is described with reference to the output electrode pedestal mounting slot 111 on the end plate 101, the horizontal direction herein may be regarded as a direction parallel to the top surface of the end plate 101 or a direction parallel to the bottom surface of the output electrode pedestal mounting slot 111.

Therefore, an installation groove 212 for improving the fixing effect may be formed on the side wall of the base 121 of the output electrode pedestal 102, and the length extension direction of the installation groove 212 on the side wall represents the first direction. The first direction has a certain angle with the horizontal direction. The first direction may be regarded as the placement direction of the output electrode pedestal 102. In the case that the output electrode pedestal 102 is placed along a direction that has a certain angle with the horizontal direction, if the angle between the placement direction of the output electrode pedestal 102 and the horizontal direction is too large, the output electrode pedestal 102 is likely to rub against the integrated busbar directly above the end plate 101 or is difficult to disassemble during the disassembly process.

Therefore, an angle M between the length extension direction of the installation groove 212, i.e. the first direction, and the top surface of the end plate 101 can be set to less than or equal to 10°, such as 0°, 1°, 2.5°, 5°, or 8°. In the case that the angle between the first direction and the top surface of the base 121 is equal to 0°, the length extension direction of the installation groove 212 is parallel to the top surface of the end plate 101. That is, when assembling the output electrode pedestal 102 by using the installation groove 212, the installation direction of the output electrode pedestal 102 is parallel to the top surface of the end plate 101, which is equivalent to being placed horizontally. By setting the angle between the first direction and the top surface of the end plate 101 within an appropriate range, the installation direction of the output electrode pedestal 102 can be adjusted to a horizontal or approximately horizontal direction, greatly reducing the impact of the integrated busbar of the battery module on the repair and maintenance of the output electrode pedestal 102. On the other hand, in the case that the output electrode pedestal 102 is engaged with the position-limiting crossbeam on the end plate 101 through the installation groove 212, it can effectively improve the fixing effect between the output electrode pedestal 102 and the end plate 101, and enhance the reliability of the output electrode pedestal 102.

In addition, in the case that the output electrode pedestal 102 is placed along a direction that has a certain angle with the horizontal direction, if the angle between the placement direction of the output electrode pedestal 102 and the horizontal direction is too small, the engagement between the installation groove 212 and the position-limiting crossbeam on the end plate 101 has limited improvement on the fixing effect of the output electrode pedestal 102, and cannot effectively improve the reliability of the placement of the output electrode pedestal 102. Therefore, the angle between the first direction and the top surface of the end plate 101 may be set within the range of 5° to 10°, such as 6°, 7°, or 8.5°. Such configuration can effectively improve the reliability of the placement of the output electrode pedestal 102 and control the interference of the integrated busbar with the repair and maintenance of the output electrode pedestal 102 within a small range.

In addition, FIG. 5 illustrates an example in which two installation grooves 212 with the same specifications and parameters are provided at the same height on opposite sides of the base 121. In specific applications, two or more sets of opposite installation grooves 212 may be provided on the side wall of the base 121, which is not limited by the embodiments of the present disclosure.

In addition, FIG. 4 illustrates an example in which an end of the installation groove 212 away from the inner wall of the output electrode pedestal mounting slot 111 is lower than an end of the installation groove 212 close to the inner wall of the output electrode pedestal mounting slot 111. In specific applications, in the case that the length extension direction of the installation groove 212 has a certain angle with the horizontal direction, the shape of the installation groove 212 may also be such that the end away from the inner wall of the output electrode pedestal mounting slot 111 is higher than the end of the installation groove 212 close to the inner wall of the output electrode pedestal mounting slot 111, which is not limited by the embodiments of the present disclosure.

In some embodiments, the first direction is parallel to the top surface of the end plate 101. The configuration that the first direction is parallel to the top surface of the end plate 101 can minimize the impact of the integrated busbar on the repair and maintenance of the output electrode pedestal 102, thereby improving the repair and maintenance efficiency of the output electrode pedestal 102.

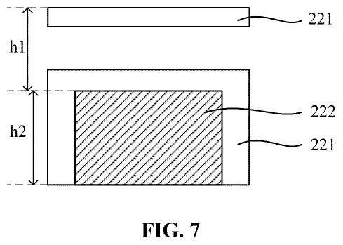

Referring to FIG. 6 and FIG. 7, in some embodiments, the side wall of the connecting pedestal 221 further includes at least one placement hole 213 that runs through the thickness of the side wall of the connecting pedestal 221; in a direction perpendicular to the top surface of the second receiving cavity 230, the thickness of the connecting portion 222 is smaller than the height of the second receiving cavity 230, and a third receiving cavity is formed between the top surface of the connecting portion 222 and the top surface of the second receiving cavity 230, the placement hole 213 directly facing the third receiving cavity and the bottom surface of the placement hole 213 being higher than the top surface of the connecting portion 222. FIG. 6 is a side view of a connecting pedestal 221, and FIG. 7 is a partial cross-sectional view of an output electrode connector 122 taken along BB1 direction.

In the process of fixedly connecting the output electrode pedestal 102 with the copper busbar or aluminum bar, generally, the aluminum bar or copper busbar may be directly placed on the top of the second receiving cavity 230, and a fastener passing through the aluminum bar or copper busbar and the opening 231 on the top of the second receiving cavity 230 is fixedly connected to the connecting portion 222 in the second receiving cavity 230 for fixed connection. However, this fixing method generally requires to provide an output electrode upper cover mounting slot on the base 121 of the output electrode pedestal 102, and then install an output electrode upper cover to further fix and protect the copper busbar or aluminum bar, which requires additional slots and components. The preparation process of the battery module is more complex and costly.

Therefore, in the direction perpendicular to the top surface of the second receiving cavity 230, the height of the second receiving cavity 230 may be set to a value greater than the thickness of the connecting portion 222, so that the connecting portion 222 has sufficient degrees of freedom in the second receiving cavity 230, and a third receiving cavity can be formed between the top surface of the connecting portion 222 and the top surface of the second receiving cavity 230, that is, there is a cavity in the second receiving cavity 230 that is not occupied by the connecting portion 222. Then, a placement hole 213 running though the thickness of the side wall of the base 121 is formed on a side wall of the connecting pedestal 221 facing the cell group in the battery module, and the bottom surface of the placement hole 213 is higher than the top surface of the connecting portion 222, that is, the placement hole 213 can directly face the third receiving cavity. In addition, the width of the placement hole 213 may be set to be greater than the width of the connecting components such as the copper busbar or aluminum bar, so that the copper busbar or aluminum bar can be placed into the third receiving cavity through the placement hole 213 and located above the connecting portion 222. Then, the fastener can be sequentially passed through the opening 231 at the top of the second receiving cavity 230 and the copper busbar or aluminum bar to be fixedly connected with the connecting portion 222. In this connection method, the part where the aluminum bar or copper busbar is connected with the connecting portion 222 is received in the third receiving cavity, and the top of the second receiving cavity 230 can directly serve as a cover plate to protect the aluminum bar or copper busbar, without the need for an additional output electrode cover plate, reducing the structural complexity and manufacturing cost of the battery module.

In addition, the present embodiment is illustrated with forming one placement hole 213 on the side wall of the connecting pedestal 221 facing the battery cell as an example. Since the connecting pedestal 221 generally adopts a symmetrical design, one placement hole 213 may be formed on each side wall of the connecting pedestal 221 facing the base 121, or two placement holes 213 may be formed on the side of the connecting pedestal 221 facing the battery cell and the side away from the battery cell, respectively, to facilitate the assembly and use of the output electrode pedestal 102, which is not limited by the embodiments of the present disclosure.

In some embodiments, in the direction perpendicular to the top surface of the second receiving cavity 230, the ratio of the height of the third receiving cavity to the thickness of the connecting portion 222 is between 0.2 and 0.8.

In the direction perpendicular to the top surface of the second receiving cavity 230, the height of the third receiving cavity refers to the spacing h1 between the top surface of the connecting portion 222 and the top surface of the second receiving cavity 230, and the thickness of the connecting portion 222 refers to the spacing h2 between the top and bottom surfaces of the connecting portion. The height of the third receiving cavity is related to the degree of freedom of the connecting portion 222 and the fixation between the connecting portion 222 and the fastener. In the case that the height of the third receiving cavity is small, the degree of freedom of the connecting portion 222 is low, and after the connecting components such as the copper busbar or aluminum bar are placed into the third receiving cavity, the posture of the connecting portion 222 is difficult to adjust, which may lead to a lower efficiency of fixedly connecting the connecting portion 222 with the fastener. In the case that the height of the third receiving cavity is large, for example, the height of the third receiving cavity is greater than the thickness of the connecting portion 222, the degree of freedom of the connecting portion 222 in the second receiving cavity 230 is too high, and part of the connecting portion 222 may turn, which may affect the connection between the connecting portion 222 and the aluminum bar or copper busbar.

Therefore, in the process of arranging the output electrode pedestal 102, in the direction perpendicular to the top surface of the second receiving cavity 230, the ratio of the height of the third receiving cavity to the thickness of the connecting portion 222 is set within a range of 0.2 to 0.8, for example, 0.25, 0.3, 0.4, 0.5, 0.65, or 0.8. Such configuration enables the connecting portion 222 to have sufficient degrees of freedom during the process of fixedly connecting the connecting portion with the aluminum bar or copper busbar, facilitates the absorption of manufacturing tolerances of connecting components such as the aluminum bar or copper busbar, and at the same time, reduces the difficulty of aligning the connecting portion 222 with connecting components such as the aluminum bar and copper busbar, and improves assembly efficiency.

In some embodiments, in the direction perpendicular to the top surface of the second receiving cavity 230, the height of the placement hole 213 is between 1 mm and 3 mm.

The height of the placement hole 213 in the direction perpendicular to the top surface of the second receiving cavity 230 refers to the spacing h3 between the bottom surface of the placement hole 213 and the top surface of the placement hole 213. Referring to the above analysis and description of the placement hole 213, the placement hole 213 is mainly used for connecting components such as the aluminum bar or copper busbar to enter the third receiving cavity. Therefore, the placement hole 213 needs to have sufficient height for connecting components to pass through the placement hole 213 and enter the third receiving cavity. In the case that the height of the placement hole 213 is too small, connecting components such as the aluminum bar and copper busbar are difficult to enter the third receiving cavity, or cannot effectively cooperate with the connecting portion 222 for pose adjustment in the third receiving cavity. In the case that the height of the placement hole 213 is too large, the connecting pedestal 221 has poor position-limiting and fixing effect on connecting components such as the aluminum bar and copper busbar, and cannot effectively protect the aluminum bar or copper busbar.

Therefore, in the direction perpendicular to the top surface of the second receiving cavity 230, the height of the placement hole 213 may be set within the range of 1 mm to 3 mm, such as 1.25 mm, 1.5 mm, 1.85 mm, 2.25 mm, or 2.75 mm. This allows connecting components such as the aluminum bar and copper busbar to easily pass through the placement hole 213 and enter the third receiving cavity, can effectively protect the safety of the connecting components during use and reduce the probability of damage to the connecting components.

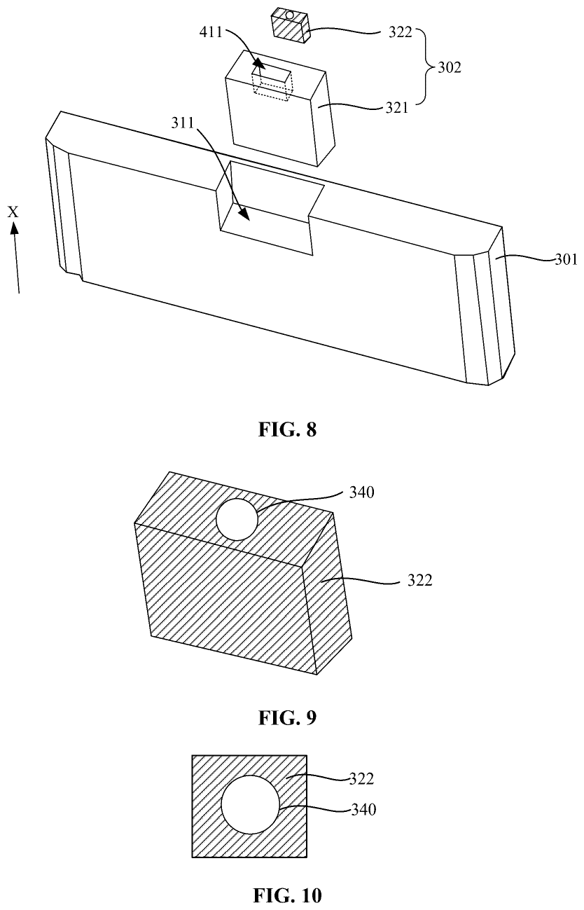

Another embodiment of the present disclosure provides another battery module. Referring to FIG. 8 and FIG. 9, FIG. 8 is a schematic structural view of an end plate, and FIG. 9 is a schematic structural view of an output electrode connector, wherein X direction represents the first direction. The battery module includes: an output electrode pedestal 302, including a base 321 and an output electrode connector 322, wherein the top surface of the base 321 has a first slot 411 extending towards the interior of the base 321 along the first direction perpendicular to the top surface of the base 321; wherein a side wall of the output electrode connector 322 is engaged with a side wall of the first slot 411, and in the first direction, the depth of the first slot 411 is greater than or equal to the length of the output electrode connector 322, and the output electrode connector 322 is able to reciprocate in the first direction within the first slot 411; and an end plate 301 including a pedestal position-limiting slot 311, a side wall of the pedestal position-limiting slot 311 being engaged with a side wall of the base 321.

For ease of understanding, FIG. 8 illustrates the example where the output electrode pedestal 302 has not been assembled and is not fixed and engaged with the end plate 301. The end plate 301 in the battery module is adjacent to an edge cell in the battery module. The pedestal position-limiting slot 311 is provided on the end plate 301 for fixing the output electrode pedestal 302. The output electrode pedestal 302 includes the base 321 of which the side wall is engaged with the side wall of the pedestal position-limiting slot 311 and the output electrode connector 322 connected to one electrode of the edge cell in the battery module. The output electrode connector 322 is electrically connected to one electrode of the edge cell through the aluminum bar or copper busbar, so that the output electrode connector 322 on the end plate 301 on one side of the battery module can serve as one output electrode in the battery module. Similarly, the output electrode connector 322 on the end plate 301 on the other side can serve as another output electrode, thereby outputting the electrical energy stored by multiple cells in the battery module.

In the process of configuring the output electrode pedestal 302, the pedestal position-limiting slot 311 may be formed on the end plate 301 first, and the output electrode pedestal 302 may be configured as a composite device composed of the base 321 and the output electrode connector 322, wherein the base 321 and the pedestal position-limiting slot 311 have similar shapes, so that the side wall and bottom surface of the base 321 can be engaged with the pedestal position-limiting slot 311, thereby securely fixing the output electrode pedestal 302 onto the end plate 301.

The depth of the pedestal position-limiting slot 311 on the end plate 301 may be greater than or equal to the height of the output electrode pedestal 302. In the case that the depth of the pedestal position-limiting slot 311 is greater than the height of the output electrode pedestal 302, the output electrode pedestal 302 is installed in a semi suspended manner, so that after the output electrode pedestal 302 is mounted on the end plate 301, only the side wall of the base 321 is engaged with the side wall of the pedestal position-limiting slot 311, and the bottom surface of the base 321 is not in contact with the end plate 301. In addition, the bottom surface of the base 321 may also be in contact with the pedestal position-limiting slot 311, further improving the engagement effect of the output electrode pedestal 302 on the end plate 301. The depth of the pedestal position-limiting slot 311 refers to the maximum extension length of the pedestal position-limiting slot 311 into the end plate 301 along a direction perpendicular to the end plate 301, and the height of the output electrode pedestal 302 refers to the maximum distance between two opposing points on the output electrode pedestal 302 along a direction perpendicular to the end plate 301.

The base 321 includes the first slot 411 extending along a direction perpendicular to the top surface of the base 321 towards the interior of the base 321. The side wall of the output electrode connector 322 can be engaged with the side wall of the first slot 411, so that the output electrode connector 322 does not rotate in the first slot 411. Furthermore, the depth of the first slot 411 is set to a value greater than or equal to the length of the output electrode connector 322, so that the output electrode connector 322 can be completely inserted into the first slot 411, that is, the top surface of the output electrode connector 322 can be flush with the top surface of the base 321 or fixed on the top surface of the base 321, thus leaving enough space on the top surface of the base 321 to facilitate the electrical connection of the output electrode connector 322 with the aluminum bar or copper busbar. Besides, as the output electrode connector 322 can reciprocate along the first direction in the first slot 411, the actual position of the electrical connection of the output electrode connector 322 with the aluminum bar or copper busbar can be flexibly adjusted, which can effectively absorb the manufacturing tolerances of electrical connectors such as the aluminum bar and copper busbar during the manufacturing process, thereby improving the reliability of the electrical connection between the output electrode base 302 and cell electrodes.

It is worth mentioning that the battery module may also include multiple cells sequentially arranged in a predetermined direction, an integrated busbar arranged on the top surface of the cells and configured on the basis of the connection method of the cells in the battery module, steel strips in contact with the end plate and the side walls of the cells for fixing and bundling the multiple cells, and other components. For ease of understanding and description, the relevant components are not shown in the figures.

Referring to FIG. 9 and FIG. 10, in some embodiments, a cross-section of the output electrode connector 322 is polygonal in the first direction. FIG. 10 is a schematic cross-sectional view of the output electrode connector 322.

In the process of configuring the output electrode pedestal 302, the output electrode connector 322 is generally in the form of a nut like component with threads or other fixing slots, and the fixed connection between the output electrode connector 322 and the aluminum bar or copper busbar is generally achieved through screw fastening. In order to prevent the output electrode connector 322 from rotating in the first slot 411, the cross-section of the first slot 411 along the first direction and the cross-section of the output electrode connector 322 along a direction perpendicular to the first direction may be configured to have the same polygonal shape, so that during the process of fixing the output electrode connector 322 and the aluminum bar or copper busbar, at least part of the side wall of the output electrode connector 322 can effectively engage with the side wall of the first slot 411, thereby restricting the rotation of the output electrode connector 322 in the first slot 411 and facilitating fixation of the output electrode connector 322 and the copper busbar or aluminum bar.

FIG. 10 illustrates the example in which the cross-section of the output electrode connector 322 is a regular quadrilateral. In some embodiments, the cross-section of the output electrode connector 322 may be in the shape of a regular polygon, such as a regular triangle, a regular quadrilateral, a regular pentagon, or a regular hexagon. The cross-section of the output electrode connector 322 may also be in the shape of an irregular polygon, such as a parallelogram, trapezoid, rectangle, or other irregular polygon, so that the output electrode connector 322 can be compatible with different scene requirements, which is not limited by the embodiments of the present disclosure.

In addition, FIG. 10 illustrates the example in which the base 321 has only one first slot 411 and one output electrode connector 322. In specific applications, the base 321 may also have two or more first slots 411, and the output electrode pedestal 302 may have output electrode connectors 322 in one-to-one correspondence with the first slots 411 or at least one output electrode connector 322, which is not limited by the embodiments of the present disclosure. In the case that the number of first slots 411 is greater than 1, the additional first slot 411 may be used as a backup slot to improve the adaptability of the output electrode pedestal 302 to installation damage or usage damage.

In some embodiments, the output electrode connector 322 has a polygonal cross-section with 3 to 6 sides.

In order to ensure that it is easy to manufacture the first slot 411 and the output electrode connector 322, and that the first slot 411 has sufficient space, the cross-sections of the first slot 411 and the output electrode connector 322 in the first direction are generally configured to be approximately regular polygons. Taking the cross-sections of the first slot 411 and the output electrode connector 322 being both regular polygons as an example, the more sides the cross-section contains, the more circular the cross-section becomes, that is, the lower the roughness of the inner wall of the first slot 411. Similarly, the more sides the cross-section contains, the lower the roughness of the side wall of the output electrode connector 322. In the case that the cross-section of the first slot 411 and the cross-section of the output electrode connector 322 contain an excessive number of sides, the engagement effect between the output electrode connector 322 and the inner wall of the first slot 411 significantly decreases, and the output electrode connector 322 is prone to rotation in the first slot 411 during the process of electrically connecting the output electrode connector 322 with the aluminum bar or copper busbar, which in turn affects the fixing effect and efficiency.

Therefore, the number of sides contained by polygons corresponding to the cross-section of the first slot 411 and the cross-section of the output electrode connector 322 may be, as described above, set within the range of 3 to 6, such as 3, 4, or 5, so that the inner wall of the first slot 411 and the side wall of the output electrode connector 322 have sufficient roughness, thereby reducing the probability of rotation of the output electrode connector 322 during the fixing process with the aluminum bar or copper busbar, and improving the fixing effect and efficiency.

In some embodiments, the depth of the first slot 411 in the first direction is less than or equal to 2 cm.

In the first direction, the depth of the first slot 411 refers to the spacing h1 between the bottom surface of the first slot 411 and the top surface of the base 321. Referring to the above description and analysis of the first slot 411 and the output electrode pedestal 302, the first slot 411 is configured to receive the output electrode connector 322 placed in the first slot 411, and enable the output electrode connector 322 to have the ability to reciprocate along the first direction within the first slot 411.

As the output electrode connector 322 is generally implemented as a structure with internal threads and connected to the aluminum bar or copper busbar through fasteners, the output electrode connector 322 itself has a certain thickness, which facilitates the provision of threads and ensures the fixing effect. The thickness of the output electrode connector 322 refers to the spacing in the first direction between the bottom and top surfaces of the output electrode connector 322 in the case that the output electrode connector 322 is placed in the first slot 411.

In the case that the thickness of the output electrode connector 322 is too large, it increases the overall cost of the battery module and also the manufacturing difficulty. Therefore, the thickness of the output electrode connector 322 in the first direction is generally within the range of 0.8 cm to 1.2 cm. Therefore, in the process of arranging the first slot 411, in the first direction, the ratio of the depth of the first slot 411 to the thickness of the output electrode connector 322 is set within the range of 1 to 2, for example, 1.05, 1.1, 1.2, 1.35, 1.5, 1.75, or 1.9. Thus, the first slot 411 can fully receive the output electrode connector 322, ensuring that the aluminum bar and copper busbar have sufficient installation space. Besides, the output electrode connector 322 can have sufficient movement space along the first direction in the first slot 411, so that the output electrode connector 322 can effectively absorb the manufacturing tolerances of connecting components such as the copper busbar or aluminum bar, and improve the quality of electrical connection between the battery cell and the output electrode pedestal 302.

In addition, based on the common thickness of the output electrode connector 322, the depth of the first slot 411 in the first direction may be set to a value less than or equal to 2 cm, such as 1.95 cm, 1.8 cm, 1.6 cm, 1.5 cm, 1.3 cm, 1.2 cm, or 1.15 cm. Such configuration can effectively receive the output electrode connector 322, and enable the output electrode pedestal 302 to have sufficient space to receive the aluminum bar or copper busbar, and the output electrode connector 322 can effectively absorb the manufacturing tolerances, effectively controlling the overall manufacturing cost and difficulty of the battery module.

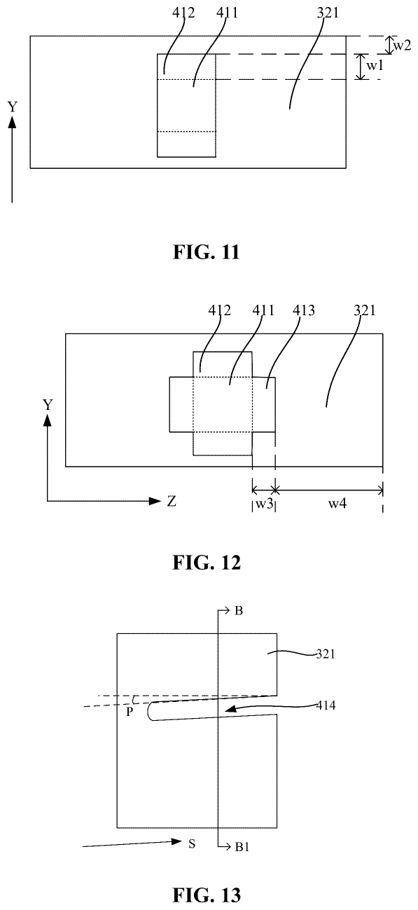

Referring to FIG. 8 and FIG. 11, in some embodiments, the top surface of the base 321 further has a second slot 412 extending towards the interior of the base 321 along the first direction and towards an edge of the base 321 along the second direction, the second slot 412 being communicated with the first slot 411; and the output electrode connector 322 is able to move along the second direction from the first slot 411 to the second slot 412 and be engaged with part of a side wall of the second slot 412. FIG. 11 is a top view of the base 321, wherein Y direction represents the second direction.

Referring to the above description and analysis of the first slot 411 and the output electrode connector 322, the purpose of configuring the output electrode connector 322 to reciprocate along the first direction within the first slot 411 is to utilize the output electrode connector 322 with a certain degree of freedom to absorb the manufacturing tolerances of the aluminum bar or copper busbar, thereby improving the reliability of electrical connection between the output electrode pedestal 302 and the battery cell in the battery module. In the case that the output electrode connector 322 has a certain degree of freedom along the first direction, the output electrode connector 322 can effectively absorb the manufacturing tolerances of the aluminum bar and copper busbar in the first direction, but can hardly absorb the manufacturing tolerances of the aluminum bar and copper busbar in the direction parallel to the top surface of the base 321. The manufacturing tolerance of the aluminum bar and copper busbar in the direction parallel to the top surface of the base 321 refers to the fact that the orthographic projections of the installation holes on the aluminum bar and copper busbar toward the top surface of the base 321 cannot completely coincide or have a low overlap rate with the installation holes of the output electrode connector 322.

Therefore, a second slot may also be provided on the top surface of the base 321, which extends towards an edge area of the base 321 along a second direction parallel to the top surface of the base 321. In the first direction, the second slot may have the same depth as the first slot 411 and communicate with the first slot, so that the output electrode connector 322 can move along the second direction from the first slot 411 to the second slot, and at least part of the side wall of the output electrode connector can be engaged with the inner wall of the second slot, avoiding rotation of the output electrode connector 322 in the second slot. In the case that a second slot is provided, the output electrode connector 322 can move along the second direction from the first slot 411 towards the edge of the base 321, effectively absorbing the manufacturing tolerances of the copper busbar or aluminum bar in the direction parallel to the top surface of the base 321. Combined with the movement along the first direction, it can effectively improve the capacity of the output electrode connector 322 for absorbing the manufacturing tolerances of connecting components, thereby improving the quality and reliability of the electrical connection between the output electrode pedestal 302 and the battery cell.

In addition, FIG. 11 illustrates the example in which the second direction is consistent with the arrangement direction of the battery cells in the battery module and the second slot 412 includes a portion close to the end plate 301 along the second direction from the first slot 411 and a portion far away from the end plate 301 along the second direction from the first slot 411. In specific applications, the second direction may also refer to other directions. For example, the second direction is parallel to the top surface of the base 321 and perpendicular to the arrangement direction of the battery cells, or the second direction is parallel to the top surface of the base 321 and has an angle of 30°, 45°, or 60° with the arrangement direction of the battery cells. In addition, the second slot 412 may only include the portion close to the end plate 301 along the second direction from the first slot 411, or may only include the portion far away from the end plate 301 along the second direction from the first slot 411, or include both, which is not limited by the embodiments of the present disclosure.

In the case that the second direction is parallel to the top surface of the base 321 and perpendicular to the arrangement direction of the battery cells, the output electrode connector 322 can effectively absorb the manufacturing tolerances of the connecting components in the horizontal direction, the horizontal direction being perpendicular to the arrangement direction of the battery cells. In the case that the second direction is parallel to the top surface of the base 321 and has an angle of 45° with the arrangement direction of the battery cells, the output electrode connector 322 can effectively absorb the manufacturing tolerances of the connecting components in different directions, thereby improving the adaptability of the battery module to different application scenarios.

In some embodiments, the extension length of the second slot 412 in the second direction is between 1 mm and 4 mm.

In the second direction, the extension length of the second slot 412 refers to the extension length of the portion of the second slot 412 that is away from the end plate 301 or the portion of the second slot 412 that is close to the end plate 301, that is, the distance w1 between the side, in the portion of the second slot 412 that is communicated with the first slot 411, communicated with the first slot 411 and the side away from the first slot 411 in the second direction. Referring to the above description and analysis of the second slot 412, the second slot 412 is for improving the capacity of the output electrode connector 322 for absorbing the manufacturing tolerances of the copper busbar or aluminum bar. The core is that the second slot 412 allows the output electrode connector 322 to have a certain degree of freedom along the second direction, that is, the ability to move a certain distance and reset along the second direction.

In the case that the extension length of the second slot 412 along the second direction is too large, due to the limited volume and size of the base 321 itself, the excessive proportion of the second slot 412 with a hollow structure leads to a decrease in the structural strength of the base 321, thereby damaging the reliability of the output electrode pedestal 302 itself. In the case that the extension length of the second slot 412 in the second direction is too small, during the process of the output electrode connector 322 moving from the first slot 411 to the second slot 412, the movement distance of the output electrode connector 322 in the second direction is short, and the degree of freedom of the output electrode connector 322 in the second direction is too low, which may not fully absorb the manufacturing tolerances of the connecting components, thereby affecting the reliability of the electrical connection between the output electrode pedestal 302 and the battery cells.

Therefore, considering the manufacturing accuracy of the connecting components and the size of the base 321, in the process of arranging the second slot 412, the extension length of the second slot 412 in the second direction may be set within the range of 1 mm to 4 mm, such as 1.25 mm, 1.5 mm, 2 mm, 2.5 mm, 3.5 mm, or 3.85 mm. Setting the extension length of the second slot 412 along the second direction within an appropriate range effectively improves the capacity of the output electrode connector 322 for absorbing the manufacturing tolerances of the connecting components and also ensures sufficient structural strength of the output electrode pedestal 302, thereby significantly improving the reliability of the electrical connection between the output electrode pedestal 302 and the battery cells.

In some embodiments, the distance between the second slot 412 and the edge of the base 321 in the second direction is between 3 mm and 10 mm.

The distance between the second slot 412 and the edge of the base 321 in the second direction refers to the distance w2 between the side of the second slot 412 close to the edge of the base 321 and the adjacent edge of the base 321. Referring to the above description and analysis of the second slot 412, the distance between the second slot 412 and the edge of the base 321 in the second direction affects the structural strength of the base 321, thereby affecting the reliability of the output electrode pedestal 302.

Therefore, in the process of arranging the second slot 412, the distance between the second slot 412 and the edge of the base 321 in the second direction may be set within the range of 3 mm to 10 mm, such as 3.5 mm, 4.5 mm, 5 mm, 7.5 mm, or 9 mm. Such arrangement allows the base 321 to have sufficient structural strength and the second slot 412 to have sufficient extension distance, ensuring the degree of freedom of the output electrode connector 322.

Referring to FIG. 8, FIG. 11 and FIG. 12, in some embodiments, the top surface of the base 321 further has a third slot 413 extending towards the interior of the base 321 along the first direction and towards the edge of the base 321 along the third direction, the third slot 413 being communicated with the first slot 411 and the third direction being perpendicular to the second direction; and the output electrode connector 322 is able to move along the third direction from the first slot 411 to the third slot 413 and be engaged with part of a side wall of the third slot 413. FIG. 12 is a top view of the base 321, wherein Y direction represents the second direction, and Z direction represents the third direction.

Referring to the above description and analysis of the second slot 412, the third slot 413 has similar structure and function as the second slot 412. The third slot 413 may also have the same slot depth as the first slot 411 and be communicated with the first slot 411, so that the output electrode connector 322 can move along the third direction from the first slot 411 to the third slot 413, and at least part of the side wall can be engaged with the inner wall of the third slot 413, avoiding rotation of the output electrode connector 322 in the third slot 413.

FIG. 12 illustrates the example in which the second direction is consistent with the arrangement direction of the battery cells in the battery module and the third direction is perpendicular to the second direction. In specific applications, both the second and third directions may refer to other directions. For example, the second direction is parallel to the top surface of the base 321 and has an angle of 30°, 45°, or 60° with the arrangement direction of the battery cells, while the third direction is perpendicular to the second direction and parallel to the top surface of the base 321. In addition, the second and third directions may not be perpendicular to each other, but have angles of 30°, 45°, or 60° with each other. In addition, the third slot 413 may only include the portion extending from the first slot 411 along the third direction towards one side edge of the base 321, or may include portions extending from the first slot 411 along the third direction towards the opposite side edges of the base 321, which is not limited by the embodiments of the present disclosure.

Due to the different extension directions of the third slot 413 and the second slot 412, the second slot 412 and the third slot 413 have good adaptability to different manufacturing tolerances of the connecting components. The arrangement that the output electrode connector 322 can move into the second slot 412 or the third slot 413 significantly improves its capacity to absorb the manufacturing tolerances of the connecting components, thereby improving the reliability of the electrical connection between the output electrode pedestal 302 and the battery cells.

In some embodiments, the extension length of the third slot in the third direction is between 1 mm and 4 mm.

In the third direction, the extension length of the third slot 413 refers to the distance w3 between the side, in the portion of the third slot 413 that is communicated with the first slot 411, communicated with the first slot 411 and the side away from the first slot 411 in the third direction. Referring to the above description and analysis of the second slot 412, in the process of arranging the third slot 413, the extension length of the third slot 413 may be set within the range of 1 mm to 4 mm, such as 1.15 mm, 1.25 mm, 1.5 mm, 2.25 mm, 2.75 mm, 3.5 mm, or 3.85 mm. Such arrangement effectively improves the capacity of the output electrode connector 322 for absorbing the manufacturing tolerances of the connecting components and also ensures sufficient structural strength of the output electrode pedestal 302, thereby significantly improving the reliability of the electrical connection between the output electrode pedestal 302 and the battery cells.

In some embodiments, the distance between the third slot 413 and the edge of the base 321 in the third direction is XX.

The distance between the third slot 413 and the edge of the base 321 in the third direction refers to the distance w4 between the side of the third slot 413 close to the edge of the base 321 and the adjacent edge of the base 321. Referring to the above description and analysis of the third slot 413, the distance between the third slot 413 and the edge of the base 321 in the third direction affects the structural strength of the base 321, thereby affecting the reliability of the output electrode pedestal 302.

Therefore, in the process of arranging the third slot 413, the distance between the third slot 413 and the edge of the base 321 in the third direction may be set within the range of 10 mm to 25 mm, such as 11 mm, 12 mm, 13.5 mm, 15 mm, 17.5 mm, 20 mm, or 23 mm. Such arrangement allows the base 321 to have sufficient structural strength and the third slot 413 to have sufficient extension distance, ensuring the degree of freedom of the output electrode connector 322.

In addition, FIG. 12 illustrates the example in which the length extension direction of the second slot 412 is consistent with the arrangement direction of the battery cells. In specific applications, in the case that the length extension direction of the third slot 413 is consistent with the arrangement direction of the battery cells, the distance between the second slot 412 and the edge of the base 321 in the second direction may be between 10 mm and 25 mm. The distance between the third slot 413 and the edge of the base 321 in the third direction is between 3 mm and 10 mm.

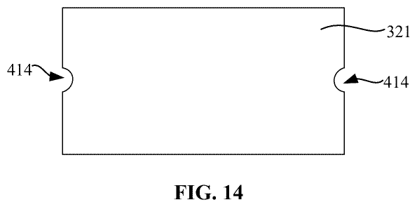

Referring to FIG. 9, FIG. 13 and FIG. 14, in some embodiments, the base 321 further includes an installation groove 414 located on the side wall of the base 321 and extending along a fourth direction, an angle between the fourth direction and the top surface of the base 321 being less than or equal to 10°; and the end plate 301 further includes a fixing portion (not shown), a side wall of the fixing portion being engaged with a side wall of the installation groove 414. FIG. 13 is a partial side view of the base 321, and FIG. 14 is a partial cross-sectional view of the base 321 taken along BB1 direction, wherein S direction represents the fourth direction.

In the process of arranging the output electrode pedestal 302, the output electrode pedestal 302 is generally vertically inserted into the pedestal position-limiting slot 311. However, after the assembly of the entire battery module is finished, the integrated busbar shields at least part of the area directly above the output electrode pedestal 302. In the case of a malfunction of the output electrode pedestal 302, the disassembly and maintenance of the output electrode pedestal 302 are difficult due to the existence of the integrated busbar.

Considering this issue, in the process of arranging the output electrode pedestal 302, the output electrode pedestal 302 may be arranged in the horizontal direction or in a direction that has a certain angle with the horizontal direction. Since the placement direction of the output electrode pedestal 302 is described with reference to the pedestal position-limiting slot 311 on the end plate 301, the horizontal direction herein may be regarded as a direction parallel to the top surface of the base 321 or a direction parallel to the bottom surface of the pedestal position-limiting slot 311.

In order to further improve the installation effect of the output electrode pedestal 302, an installation groove 414 for improving the fixing effect may be formed on the side wall of the base 321 of the output electrode pedestal 302, and the length extension direction of the installation groove 414 on the side wall represents the fourth direction. The fourth direction has a certain angle with the horizontal direction. The fourth direction may be regarded as the placement direction of the output electrode pedestal 302. The arrangement of the installation groove 414 is similar to that of the installation groove 212 in the previous embodiment, and also achieves similar technical effects, which will not be repeated here.

It is worth mentioning that the features in the above embodiments cannot only exist separately in the battery module, but can also be combined with each other without technical conflicts and without exceeding the inventive concept of the embodiments of the present disclosure, which will not be specifically described here.

In summary, embodiments of the present disclosure provide a battery module. An output electrode pedestal mounting slot is provided on an end plate of the battery module, and an output electrode pedestal is composed of a base and an output electrode connector, wherein the side wall of the base can be engaged with the side wall of the output electrode pedestal mounting slot, so that the output electrode pedestal can be securely installed on the end plate and can accurately anchor the connection position of the output electrode pedestal with the aluminum bar or copper busbar; the top surface of the base of the output electrode pedestal has a first receiving cavity extending from the top surface of the base towards the interior of the base and configured to receive the output electrode connector, wherein the output electrode connector is composed of a connecting pedestal engaged with the side wall of the first receiving cavity and a connecting portion located in a second receiving cavity of the connecting pedestal, wherein the side wall of the connecting pedestal is engaged with the side wall of the first receiving cavity so that the output electrode connector can be securely fixed in the base; the top surface of the connecting pedestal has an opening that runs through the top of the second receiving cavity, and the connecting portion can move in translation in the receiving cavity, so that the actual connection position of the connecting portion with the aluminum bar or copper busbar can be finely adjusted, thereby absorbing the manufacturing tolerance of the aluminum bar or copper busbar in the manufacturing process, improving the reliability of the electrical connection between the connecting portion and the aluminum bar or copper busbar, and facilitating the assembly of the battery module.

Correspondingly, embodiments of the present disclosure further provide a battery pack including the battery module provided in the above embodiments, with the same or corresponding technical features as the above embodiments, which will not be described in detail here.

In some embodiments, the battery pack includes multiple battery modules as described in any one of the above embodiments.

In some embodiments, the battery pack may be a pack in an energy storage cabinet, wherein multiple battery modules are arranged in a regular pattern to form one energy storage battery pack. The specific quantity of the battery modules can be set according to needs, which is not specifically limited herein. For example, the battery modules may be grouped into one group, two groups, four groups, five groups, six groups, etc.

In some embodiments, the battery pack further includes a battery management system (BMS), which can be used to detect the working parameters of each battery module and regulate the working status of each battery module.

Although the present disclosure has been disclosed above in the way of preferred embodiments, these preferred embodiments are not intended to define the claims. Any person skilled in the art may make several possible changes and modifications without departing from the concept and scope of the present disclosure. Therefore, the scope of protection of the present disclosure should be subject to the scope defined by the appended claims of the present disclosure.

What is claimed is:

1. A battery module, comprising:
an end plate, comprising an output electrode pedestal mounting slot; and
an output electrode pedestal, comprising a base and an output electrode connector, wherein a side wall of the base is engaged with a side wall of the output electrode pedestal mounting slot, and the base comprises a first receiving cavity extending from a top surface of the base to an interior of the base; wherein the output electrode connector comprises a connecting pedestal and a connecting portion, the connecting pedestal comprises a second receiving cavity, a top surface of the connecting pedestal has an opening that runs through a top of the connecting pedestal to expose the connecting portion inside the second receiving cavity, a side wall of the connecting pedestal is engaged with a side wall of the first receiving cavity, and the connecting portion is located in the second receiving cavity and movable in translation within the second receiving cavity.

2. The battery module according to claim 1, wherein a maximum translation distance of the connecting portion within the second receiving cavity is less than or equal to 8 mm.

3. The battery module according to claim 1, wherein an inner wall of the first receiving cavity comprises at least two opposite position-limiting slots, and an outer wall of the connecting pedestal has at least two opposite position-limiting portions, each of the at least two position-limiting portions being engaged into a corresponding position-limiting slot.

4. The battery module according to claim 1, wherein in a direction perpendicular to the top surface of the second receiving cavity, a first cross-section of the second receiving cavity is polygonal, and a second cross-section of the connecting portion is polygonal.

5. The battery module according to claim 4, wherein a number of sides of the first cross-section and/or the second cross-section is 3 to 6.

6. The battery module according to claim 4, wherein the first cross-section and the second cross-section have the same shape.

7. The battery module according to claim 1, wherein the base further comprises an installation groove located on the side wall of the base and extending along a first direction, an angle between the first direction and a top surface of the end plate being less than or equal to 10°; and
the end plate further comprises a position-limiting crossbeam, a side wall of the position-limiting crossbeam being engaged with a side wall of the installation groove.

8. The battery module according to claim 7, wherein the first direction is parallel to the top surface of the end plate.

9. The battery module according to claim 1, wherein the side wall of the base further comprises at least one placement hole running through a thickness of the side wall of the base;
in a direction perpendicular to the top surface of the second receiving cavity, a thickness of the connecting portion is smaller than a height of the second receiving cavity, and a third receiving cavity is formed between a top surface of the connecting portion and the top surface of the second receiving cavity, the placement hole directly facing the third receiving cavity and a bottom surface of the placement hole being higher than the top surface of the connecting portion.

10. The battery module according to claim 9, wherein in a direction perpendicular to the top surface of the second receiving cavity, the height of the placement hole is between 1 mm and 3 mm.

11. A battery pack, comprising:
a plurality of battery modules according to claim 1.

12. The battery pack according to claim 11, wherein a maximum translation distance of the connecting portion within the second receiving cavity is less than or equal to 8 mm.

13. The battery pack according to claim 11, wherein an inner wall of the first receiving cavity comprises at least two opposite position-limiting slots, and an outer wall of the connecting pedestal has at least two opposite position-limiting portions, each of the at least two position-limiting portions being engaged into a corresponding position-limiting slot.

14. The battery pack according to claim 11, wherein in a direction perpendicular to the top surface of the second receiving cavity, a first cross-section of the second receiving cavity is polygonal, and a second cross-section of the connecting portion is polygonal.

15. The battery pack according to claim 14, wherein a number of sides of the first cross-section and/or the second cross-section is 3 to 6.

16. The battery pack according to claim 14, wherein the first cross-section and the second cross-section have the same shape.

17. The battery pack according to claim 11, wherein the base further comprises an installation groove located on the side wall of the base and extending along a first direction, an angle between the first direction and a top surface of the end plate being less than or equal to 10°; and
the end plate further comprises a position-limiting crossbeam, a side wall of the position-limiting crossbeam being engaged with a side wall of the installation groove.

18. The battery pack according to claim 17, wherein the first direction is parallel to the top surface of the end plate.

19. The battery pack according to claim 11, wherein the side wall of the base further comprises at least one placement hole running through a thickness of the side wall of the base;
in a direction perpendicular to the top surface of the second receiving cavity, a thickness of the connecting portion is smaller than a height of the second receiving cavity, and a third receiving cavity is formed between a top surface of the connecting portion and the top surface of the second receiving cavity, the placement hole directly facing the third receiving cavity and a bottom surface of the placement hole being higher than the top surface of the connecting portion.

20. The battery pack according to claim 19, wherein in a direction perpendicular to the top surface of the second receiving cavity, the height of the placement hole is between 1 mm and 3 mm.
